(19) United States
(12) Patent Application Publication
(10) Pub. No.: US 2009/0125279 A1
(43) Pub. Date: May 14, 2009

(54) CIRCUITRY AND METHODS FOR TIME DOMAIN CHANNEL DE-EMBEDDING

(75) Inventor: Boris Fakterman, Haifa (IL)

Correspondence Address: Alan K. Aldous;Intel Corporation, c/o Intellevate, LLC, P.O. Box 52050, Minneapolis, MN, 55402, US

(73) Assignee: Intel Corporation

(21) Appl. No.: 11/939,694

(22) Filed: Nov. 14, 2007

(51) Int. Cl. G06F 19/00

(52) U.S. Cl. 702/189

(57) ABSTRACT

In some embodiments, an apparatus includes a tester having de-embedding logic and analysis logic. The de-embedding logic is to receive a differential tester input signal in a time domain fashion and in response to the tester input signal to provide a differential de-embedded signal that is an estimate of a time domain differential channel input signal including first and second channel input signal components outside the tester. The tester input signal is responsive to the channel input signal, and the tester input signal includes first and second tester input signal components, and the de-embedded signal includes first and second de-embedded signal components. The analysis logic is to receive the de-embedded signal and draw conclusions about a device under test outside the tester providing the channel input signal. To provide the de-embedded signal, the de-embedding logic performs operations involving channel ABCD parameters, source impedance characteristics, and load impedance characteristics. Additional embodiments are described.

### BACKGROUND

1. Technical Field

Embodiments of the invention relate generally to circuitry and methods for determining the voltage and/or current of transmitters of a device under test through channel de-embedding.

2. Background Art

A common communication model consists of a transmitter, channel and receiver. In many cases a received signal is measured in a time domain and voltage of the transmitter signal is estimated. For example the PCI Express® Base Specification Revision 2.0 (PCI-E Gen2), Dec. 20, 2006, chapter 4.3.3.6, page 250, discusses transmitter measurements as follows:

“When measuring a Transmitter, it is not usually feasible to place the probes directly at the Transmitter's pins, so it is typical to have PCB traces and other structures between the Tx package and the probe location. If direct measurement cannot be made at the Tx pins, then it will be necessary to deconvolve the effects compliance test board from the measurement.”

A common practice today is measuring the signal from a transmitter at a printed circuit board (PCB) trace. An oscilloscope has been used in connection with a device under test (DUT) tester to measure the time domain signal at the PCB trace. The trace may distort the signal and give an incorrect view of the DUT transmitter output voltage and/or current. The problem will increase with introduction of 5 GHz and 10 GHz interconnects such as PCI-E Gen2 and IEEE 802.3 10 GBASE-KR. A network analyzer has been used to characterize the PCB trace. The trace may be characterized in units referred to as s-parameters, which are frequency parameters of an electro-magnetic wave. De-embedding techniques have been used to correct for the time domain signal distortion and have involved converting s-parameters to ABCD parameters. Heretofore, the de-embedding techniques have occurred in frequency domain.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 is a block diagram representation of a system including a DUT on a circuit board coupled to a tester according to some embodiments of the invention.

FIG. 2 is a block diagram representation of some implementations of the tester of FIG. 1.

FIG. 3 is a block diagram representation of differential channels between the transmitter and tester of FIG. 1 according to some embodiments of the invention.

FIG. 4 is a block diagram representation of a signal ended channel between a transmitter and tester similar to or the same as those used in FIG. 1 according to some embodiments.

FIG. 5 shows an equation including prior art two port ABCD parameters for use in some embodiments of the invention.

FIG. 6 shows an equation including prior art four port ABCD parameters for use in some embodiments of the invention.

FIG. 7 illustrates representations of a two port circuit for a signal ended channel for S-parameter and ABCD parameters that may be used in connection with some embodiments of the invention.

FIG. 8 illustrates representations of a four port circuit for a differential channel for S-parameter and ABCD parameters that may be used in connection with some embodiments of the invention.

FIG. 9 shows an equation that may be used in calculating a DUT voltage according to some embodiments of the invention.

FIG. 10 is a representation of a source matrix that may be used in connection with some embodiments of the invention.

FIG. 11 is a representation of a load matrix that may be used in connection with some embodiments of the invention.

FIG. 12 is a system similar to that of FIG. 1 that shows additional channels according to some embodiments of the invention.

### DETAILED DESCRIPTION

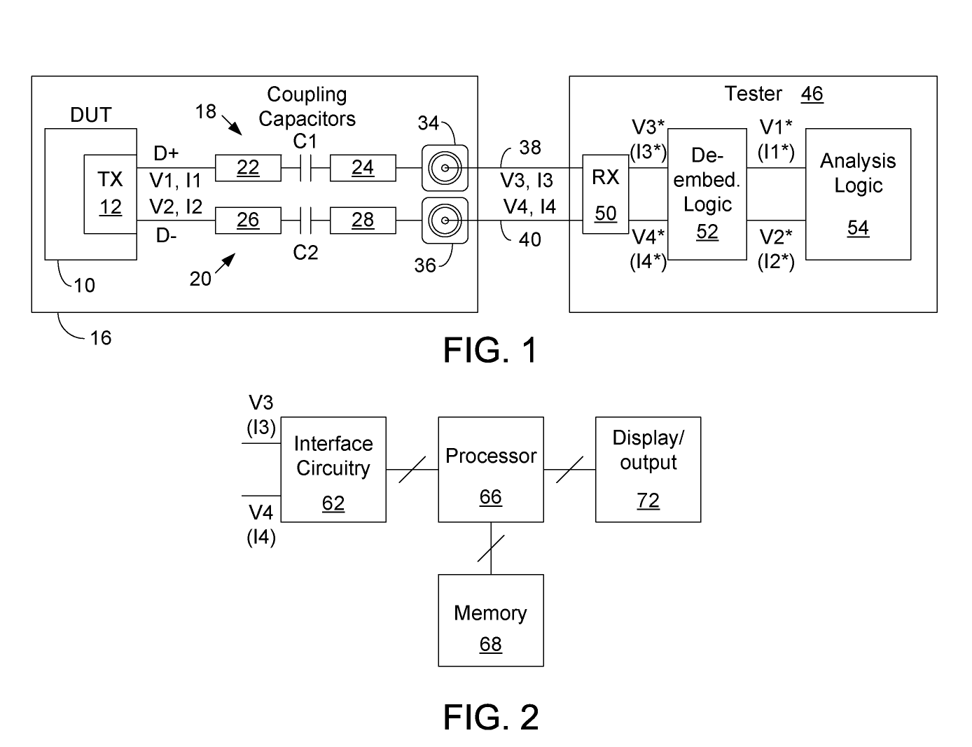

Referring to FIG. 1, a system includes a DUT 10 supported by a circuit board 16, which may be a PCB. DUT 10 includes a transmitter (TX) 12 that provides a differential signal with D+ and D− signal components to channels 18 and 20. The transmitter can also be called the source. The differential signal may be referred to as either the transmitter output signal or the channel input signal. The D+ signal component has voltage V1 and current I1, and the D− signal component has voltage V2 and current I2. In FIG. 1, channels 18 and 20 include traces in circuit board 16 coupled to connectors 34 and 36, such as, for example, prior art SMA (SubMiniature version A) connectors. The traces in circuit board 16 include conductors 22 and 24 of channel 18 and conductors 26 and 28 of channel 20. Some embodiments include coupling capacitors C1 and C2.

Conductors 38 and 40 couple connectors 34 and 36 to tester 46. As examples, tester 46 may include an oscilloscope and/or logic analyzer. Conductor 38 carries a signal having a voltage V3 and a current I3, and conductor 40 carries a signal having a voltage V4 and a current I4. The magnitudes of currents I3 and I4 may be the same as the magnitudes of I1 and I2. In some embodiments, tester 46 includes a receiver (RX) 50 that receives the signals on conductors 38 and 40 and provides received versions of them to de-embedding logic 52. In some embodiments, RX 50 is an oscilloscope. In other embodiments, RX 50 is something else or is not included at all. The signals provided by RX 50 have voltages V3* and V4*, and current I3* and I4*, which are ideally the same as voltages V3 and V4, and currents I3 and I4. In some embodiments, RX 50 is designed such that voltages V3* and V4* are the same V3 and V4, but currents I3* and I4* are not necessarily the same as currents I3 and I4. The signals received by either RX 50 or de-embedding logic 52 may be considered tester input signals.

In some embodiments, de-embedding logic 52 is hardware circuitry, and in other embodiments, it includes a processor, such as a digital signal processor (DPS), microprocessor, or embedded processor, or a combination of hardware and a processor. In some embodiments, de-embedding logic 52 provides differential signals having de-embedded voltages V1* and V2* which are ideally the same as originally transmitted voltages V1 and V2. Analysis logic 54 receives the signals having voltages V1* and V2* and draws conclusions about DUT 10, such as whether it is operating properly. In some embodiments or modes, the signals provided by de-embedding logic 52 have currents I1* and I2*. In some embodiments or modes, I1* and I2* are ideally the same as currents I1 and I2, but in other embodiments or modes, that is not the case.

FIG. 2 illustrates portions of some embodiments of tester 46, but other embodiments of tester 46 do not include some of these details. Referring to FIG. 2, interface circuitry 62 receives signals on conductors 38 and 40 that having voltages V3 and V4 and provides signals representative thereof to processor 66. For example, interface circuitry 62 may include analog-to-digital converters to provide digital signals to processor 66. Processor 66 performs instructions that are stored on memory 68. Memory 68 may be flash memory, dynamic random access memory (DRAM), a hard-drive, or some other sort of memory. In some embodiments, memory 68 is also used to store data. In some embodiments, processor 66 performs some or all the functions of both de-embedding logic 52 and analysis logic 54. A display and/or other output circuitry may be used to provide conclusions of the analysis.

FIG. 3 illustrates a more schematic version of the structure of FIG. 1. In the case of FIG. 3, V1 and V2 are the transmitter output signals to be estimated, and V3 and V4 are the channel output signals measured by the tester.

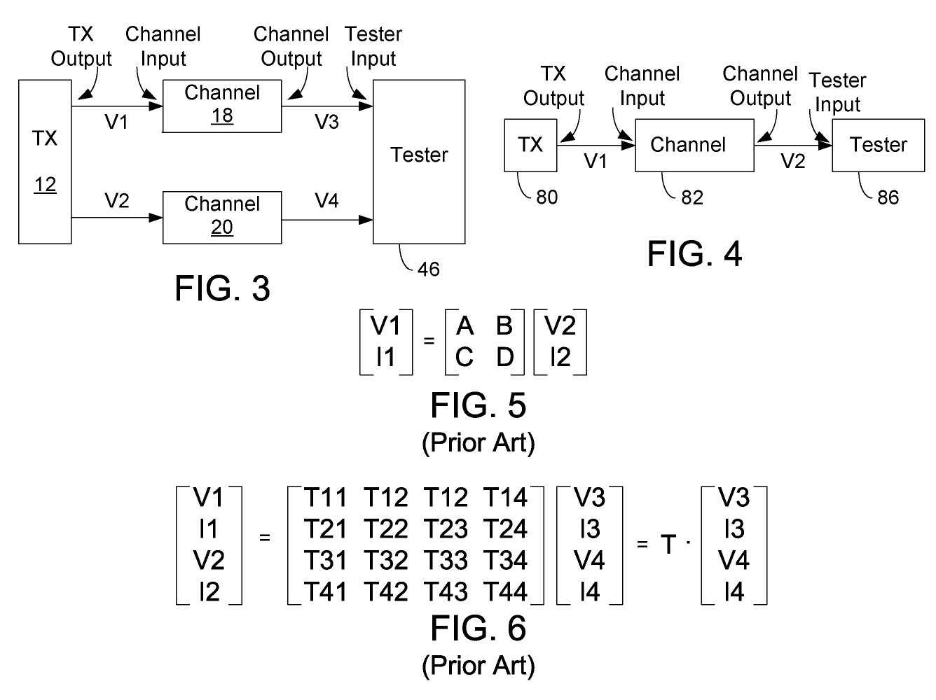

FIG. 4 is similar to FIGS. 1 and 3, but includes a single ended TX 80, channel 82, and tester 86. Some testers have both single ended and differential capability. In the case of FIG. 4, V1 is the transmitter output signal to be estimated and V2 is the channel output signal measured by the tester.

In some embodiments, there are capacitors between the channel and the tester, but that is not the case in other embodiments.

In the illustrated example, the channel input is the output of TX 12 or TX 80 and the channel output is the input of tester 46 (ignoring connectors 34 and 46). In some embodiments, an inventive algorithm described below uses measurements performed after the PCB traces to derive signals at the transmitter outputs. More generally speaking, in some embodiments, the algorithm uses time domain measurements at the channel output to derive the time domain signal at the channel input. The algorithm may significantly reduce the number of incorrect component failures.

S-parameters and ABCD parameters are well known and described in the prior art literature. Two port ABCD parameters are represented in matrices as shown in FIG. 5. Four port ABCD parameters are represented in matrices as shown in FIG. 6. The four port ABCD matrix is called T in this disclosure.

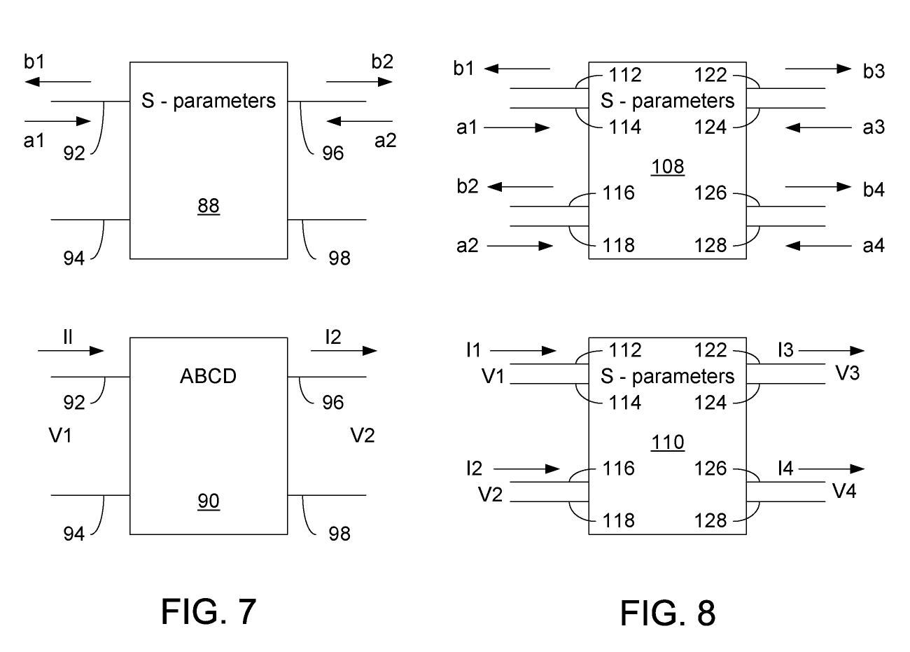

FIG. 7 is a generalized representation of s-parameters 88 of a two port (single ended) channel between signal conductor ends 92 and 96 with incident waves a1 and a2 and reflected waves b1 and b2. Ground is represented with reference numbers 94 and 98. Ground is included in the system of FIG. 4, but is not shown in FIG. 4. FIG. 7 also includes a corresponding generalized representation of ABCD parameters 90 with currents I1 and I2 and voltages V1 and V2.

FIG. 8 is a generalized representation of s-parameters 108 of a four port (differential) channel between signal conductor ends 112, 116 and 122, 126 with incident waves a1, a2, a3, and a4, and reflected waves b1, b2, b3, and b4. Ground is represented with reference numbers 114, 118, 124, and 128. Ground is included in the system of FIGS. 1 and 3, but is not shown in them. FIG. 8 also includes a corresponding generalized representation of ABCD parameters 110 with currents I1, I2, I3, and I4, and voltages V1, V2, V3, and V4.

The following algorithm is used in some embodiments. In other embodiments, the algorithm is different. A network analyzer or other instrument in tester 46 (or tester 86) may measure the channel s-parameters in the frequency domain. Tester 46 (or tester 86) transforms S-parameters into ABCD parameters. Tester 46 samples voltages V3 and V4 in the case of differential channels as in FIG. 3, and tester 86 samples voltage V2 in the case of single ended channels as in FIG. 4. Tester 46 (or tester 86) transfers the measured signal to the frequency domain using a Fourier transform. A filtering algorithm (discussed below) may be used to filter background noise.

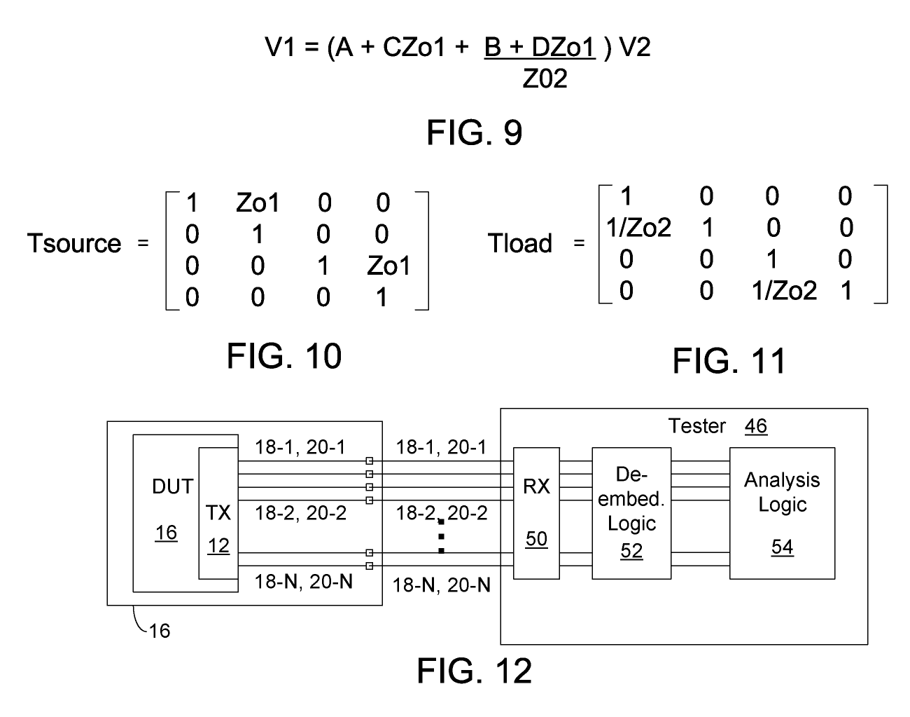

An input signal calculation may be performed as follows. The equation of FIG. 9 relates the single ended circuit of FIG. 4 described by equation in FIG. 5. V1 and V2 are input and output voltages, where A, B, C, and D are ABCD parameters, Zo1 is the transmitter output impedance load and Zo2 is the tester input impedance load. The measurement of Zo1 may be made for one board or a few boards to get an accurate value and then reused in connection with other DUTs on the same or very similar boards. The value of Zo2 may be provided by the tester manufacturer or measured using network analyzer. The calculated input signal V1 is transferred to the time domain using an inverse Fourier transform.

For use in the differential case related to the circuit described in the picture in FIG. 3 and in the equation in FIG. 6, the equations of FIGS. 10 and 11 show T_{load} and T_{source} matrices, where T_{source} is an impedance of the transmitter output and T_{load} is an impedance of tester 46 as reviewed from the channels. A product matrix N is defined in equation (1) as follows:

N=T_{source}*T*T_{load} (1)

wherein matrix T is shown in FIG. 6, matrix T_{source} is shown in FIG. 10, and matrix T_{load} is shown in FIG. 11. N is called the product matrix because it is the product of multiplication. The matrix T includes characteristics of the path from TX 12 to tester 46 including channels 18 and 20. The values of T can be obtained from measurement. The matrix T_{source} includes impedance characteristics of transmitter 12 and the matrix T_{load} includes impedance characteristics of the input of tester 46.

The channel input voltage signals V1 and V2 can be calculated by tester 46 by using the following equations (2) and (3).

V1=N11×V3+N13×V4 (2)

V2=N31×V3+N33×V4 (3)

wherein V1, V2, V3, and V4 are the voltages of FIG. 1, N11 is row 1, column 1 of the matrix N of equation (1); N13 is row 1, column 3 the matrix N of equation (1), N31 is row 3, column 1 of the matrix N of equation (1); N33 is row 3, column 3 the matrix N of equation (1).

Note that equations (2) and (3) are just for the V terms. In some embodiments, the I terms I1 and I2 can be obtained by replacing V3 and V4 with I3 and I4 and replacing N11, N13, N31, and N33 with N22, N24, N42, and N44.

The calculated input signals V1 and V2 for the differential case can be transferred to the time domain using an inverse Fourier transform.

Signals measured by an oscilloscope or other tester contains instrument internal noise. This noise may be increased by a de-embedding algorithm and may mask signals. Accordingly, in some embodiments, the noise may be filtered before de-embedding the algorithm is applied. There are various ways in which the filtering algorithm may be implemented removing background noise from the whole measured spectrum or from the part of the measured spectrum. In some embodiments, the filtering algorithm includes the following details, while in other embodiments it includes somewhat different details—and in still other embodiments, the filtering algorithm is not used. In some embodiments, a noise power mean level is found. For each bin in a frequency domain, bin power is compared with the noise power mean level. The following is some pseudo code.

If bin power−noise power >10 dB, leave the bin as is,

Else new_bin_magnitude=previous_bin_magnitude/10000

End

As an example, the algorithm is tested by measuring a 3.125 GHz signal with the oscilloscope at the channel input and at the channel output. Then, the channel input is estimated from the channel output measurement using the algorithm and compared to the channel input measurement.

As a result of the de-embedding process described herein, fewer components may be failed during the DUT test process.

### ADDITIONAL INFORMATION AND EMBODIMENTS

The “logic” referred to herein can be implemented in circuits, software, microcode, or a combination of them.

An embodiment is an implementation or example of the invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments.

When it is said the element “A” is coupled to element “B,” element A may be directly coupled to element B or be indirectly coupled through, for example, element C.

When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” Likewise, that A is responsive to B, does not mean it is not also responsive to C.

If the specification states a component, feature, structure, process, or characteristic “may”, “might”, or “could” be included, that particular component, feature, structure, process, or characteristic is not required to be included. If the specification or claim refers to “a” or “an” element, that does not mean there is only one of the element.

The invention are not restricted to the particular details described herein. Indeed, many other variations of the foregoing description and drawings may be made within the scope of the present invention. Accordingly, it is the following claims including any amendments thereto that define the scope of the invention.

What is claimed is:

1. An apparatus comprising:
a tester including:
de-embedding logic to receive a differential tester input signal in a time domain fashion and in response to the tester input signal to provide a differential de-embedded signal that is an estimate of a time domain differential channel input signal including first and second channel input signal components outside the tester, wherein the tester input signal is responsive to the channel input signal, and wherein the tester input signal includes first and second tester input signal components, and the de-embedded signal includes first and second de-embedded signal components; and
analysis logic to receive the de-embedded signal and draw conclusions about a device under test outside the tester providing the channel input signal;
wherein to provide the de-embedded signal, the de-embedding logic performs operations involving channel ABCD parameters, source impedance characteristics, and load impedance characteristics.

2. The apparatus of claim 1, wherein the first component of the de-embedded signal is the sum of the first component of the tester input signal multiplied by a first element of a product matrix and the second component of the tester input signal multiplied by a second element of the product matrix, and wherein the second component of the de-embedded signal is the sum of the first component of the tester input signal multiplied by a third element of the product matrix and the second component of the tester input signal multiplied by a fourth element of the product matrix.

3. The apparatus of claim 2, wherein the product matrix is the product of the multiplication of an ABCD matrix, a source matrix characterizing a source of the channel input signal, and a load matrix characterizing the tester load on the channels.

4. The apparatus of claim 3, wherein the source matrix includes the following elements:
$$[ \begin{matrix}1 & Z o 1 & 0 & 0 \\ 0 & 1 & 0 & 0 \\ 0 & 0 & 1 & Z o 1 \\ 0 & 0 & 0 & 1\end{matrix} ] .$$

5. The apparatus of claim 3, wherein the load matrix includes the following elements:
$$[ \begin{matrix}1 & 0 & 0 & 0 \\ 1 / Z o 2 & 1 & 0 & 0 \\ 0 & 0 & 1 & 0 \\ 0 & 0 & 1 / Z o 2 & 1\end{matrix} ] .$$

6. The apparatus of claim 3, wherein the first element is at a first row and a first column of the product matrix, the second element is at the first row and a third column of the product matrix, the third element is at a third row and the first column of the product matrix, and the fourth element is at the third row and the third column of the product matrix.

7. The apparatus of claim 1, wherein the first and second de-embedded signal components are voltage signals.

8. The apparatus of claim 1, wherein the first and second de-embedded signal components are current signals.

9. The apparatus of claim 1, further comprising:
a circuit board including a first and second channels to receive the first and second components of the differential channel input signal;

10. The apparatus of claim 9, further comprising:
the device under test supported by the circuit board, wherein the device under test is the source of the channel input signal.

11. The apparatus of claim 1, wherein the de-embedding logic includes a processor to execute software operations to provide the de-embedded signal.

12. A method comprising:
receiving a differential tester input signal in a time domain fashion that is responsive to a time domain differential channel input signal provided through first and second channels;
providing a differential de-embedded signal that is an estimate of the differential channel input signal, wherein the differential channel input signal includes first and second channel input signal components, the tester input signal includes first and second tester input signal components, and the de-embedded signal includes first and second de-embedded signal components, wherein to provide the de-embedded signal, the de-embedding logic performs operations involving channel ABCD parameters, source impedance characteristics, and load impedance characteristics; and
analyzing the de-embedded signal and drawing conclusions about a device under test providing the channel input signal.

13. The method of claim 12, wherein the first component of the de-embedded signal is the sum of the first component of the tester input signal multiplied by a first element of a product matrix and the second component of the tester input signal multiplied by a second element of the product matrix, and wherein the second component of the de-embedded signal is the sum of the first component of the tester input signal multiplied by a third element of the product matrix and the second component of the tester input signal multiplied by a fourth element of the product matrix.

14. The method of claim 13, wherein the product matrix is the product of the multiplication of an ABCD matrix, a source matrix characterizing a source of the channel input signal, and a load matrix characterizing the tester load on the channels.

15. The method of claim 12, wherein the first and second de-embedded signal components are voltage signals.

16. The method of claim 12, further comprising filtering noise and binning based on the filtering.

17. An apparatus comprising:
a tester including:
de-embedding logic to receive a tester input signal in a time domain fashion and in response to the tester input signal to provide a de-embedded signal that is an estimate of a time domain channel input signal outside the tester, wherein the tester input signal is responsive to the channel input signal,
analysis logic to receive the de-embedded signal and draw conclusions about a device under test outside the tester providing the channel input signal;
wherein to provide the de-embedded signal, the de-embedding logic performs operations involving ABCD parameters, at least one signal characterizing a source of the channel input signal, and at least one signal characterizing the tester load on the channels.

18. The apparatus of claim 17, wherein to provide the de-embedded signal, the de-embedding logic performs the operations according to the following equation:
V1=(A+CZo1+(B+DZo1)/Zo2)V2,
wherein V1 is the channel input voltage, V2 is the tester input signal, Zo1 is an output impedance load of the source, Zo2 is an input impedance load of a tester including the de-embedding logic, and A, B, C, and D are ABCD parameters.

19. The apparatus of claim 1, further comprising:
a circuit board including a channel to receive the channel input signal; and
the device under test supported by the circuit board, wherein the device under test is the source of the channel input signal.

20. The apparatus of claim 1, wherein the de-embedding logic includes a processor to execute software operations to provide the de-embedded signal.
